(19) United States
(12) Patent Application Publication
(10) Pub. No.: US 2026/0246539 A1
(43) Pub. Date: Aug. 20, 2026

(54) Binary Encryption System Based on Multiple Light Negative Refraction Interference Patterns and Light Wavelengths Interception Patterns Created by the Interaction of a Multi-Laser Array System with Anisotropic Optical Metamaterials and by the Interaction of a Multi-Laser Array System with a Multi-Prism Function Metamaterials to Generated Multi-Light Wavelength Interceptions for Digital Communication and Computerized Systems Managed by Artificial Intelligence

(71) Applicant: Joseph Carlo Pastrana, Sneads Ferry, NC (US)

(72) Inventor: Joseph Carlo Pastrana, Sneads Ferry, NC (US)

(21) Appl. No.: 19/404,731

(22) Filed: Dec. 1, 2025

(51) Int. Cl. H04B 10/85; H04L 9/40

(52) U.S. Cl. CPC H04B 10/85; H04L 9/40

(57) ABSTRACT

A Binary Encryption System based on multiple Negative Refraction interference patterns and a diverse assemblage of light wavelengths interception patterns driven by Artificial Intelligence (AI) wherein a Multi-Laser Array System comprised of multiple laser beams (light beams) operating simultaneously interact with rotatable Anisotropic Optical Metamaterials to generate Negative Refraction interference patterns and where laser beams operating simultaneously also interact with rotatable metamaterials designed to function as a Multi-Prism Unit to generate multiple sub-arrays with different wave amplitudes and different light wavelengths interception patterns to form the basis of the binary encryption system for the security of computer systems and digital communications.

### CROSS-REFERENCE TO RELATED APPLICATIONS

Not applicable to this application

### FEDERALLY SPONSORED RESEARCH OR DEVELOPMENT

Not applicable to this application

### SEQUENCE LISTING, A TABLE, OR A COMPUTER PROGRAM LISTING

Not applicable to this application

### COMPACT DISK APPENDIX

Not applicable to this application

### STATEMENT REGARDING PRIOR DISCLOSURES BY THE INVENTOR

Not applicable to this application

### BACKGROUND OF THE INVENTION

The technical field of the invention relates to the security of data processed by computer systems and digital communication systems. More particularly, the present invention relates to the field of data encryption, and how data is managed, stored and transmitted securely by computer systems and computerized communication systems. To improve data security, the method utilizes Artificial Intelligence (AI) and a binary encryption system based on multiple light negative refraction interference patterns and light wavelengths interception patterns created by the interaction of a multi-laser array system with anisotropic optical metamaterials and laser-generated multi-light wavelength interceptions to secure computerized communication systems. Accordingly, increasing the complexity of encryptions to protect data is highly desirable for computer systems and computerized communication systems.

### DESCRIPTION OF PRIOR ART

N/A

### BRIEF SUMMARY OF THE INVENTION

An Artificial Intelligence Driven (AI-Driven) Binary Encryption System based on multiple Light Negative Refraction interference patterns generated by a Multiple Angle-Independent Multi-Laser Array System interacting with Anisotropic Optical Metamaterials and wherein each angle-independent laser beam also generates different wavelengths to create interception patterns to form the basis of the encryption system and where the negative refraction interference patterns and the wavelengths interception patterns are either operating simultaneously in parallel or in a state of continuously alternation to enhance the complexity of the binary encryption system intended for the security of computer systems and digital communications.

### BRIEF DESCRIPTION OF THE SEVERAL VIEWS OF THE DRAWINGS

FIG. 1 depicts the Laser Array System Components (unassembled) which Artificial Intelligence (AI) manage to generate the required multiplicity of Light Wavelengths and Negative Refractions to support the encryption process, and to control the Rotation of Metamaterials, Speed of Metamaterial Rotations, Direction of Rotations, Morse-Type Function, Angle of Each Laser Beam, and Intersection of Wavelengths with Negative Refraction Angles of the encryption system.

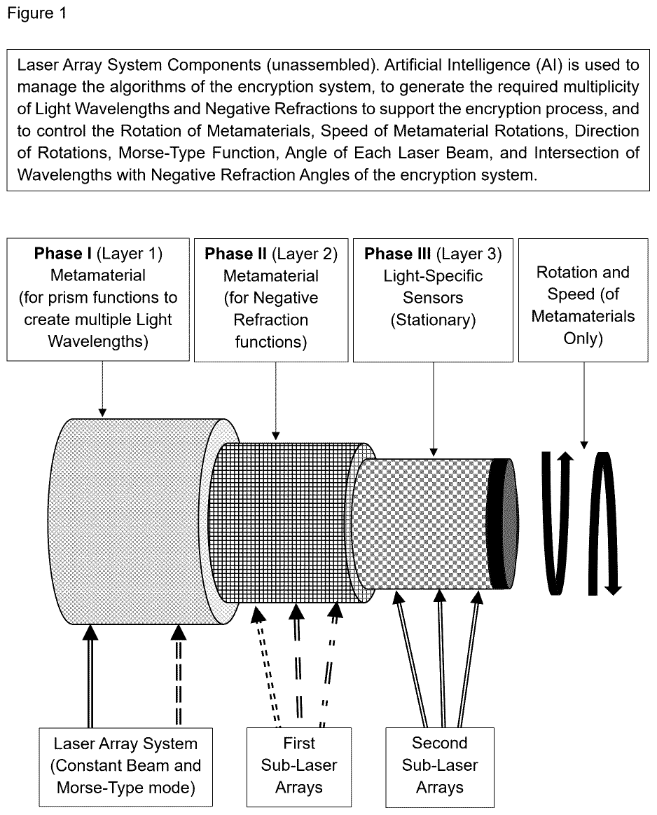

FIG. 2 depicts the Laser Array System Components assembled.

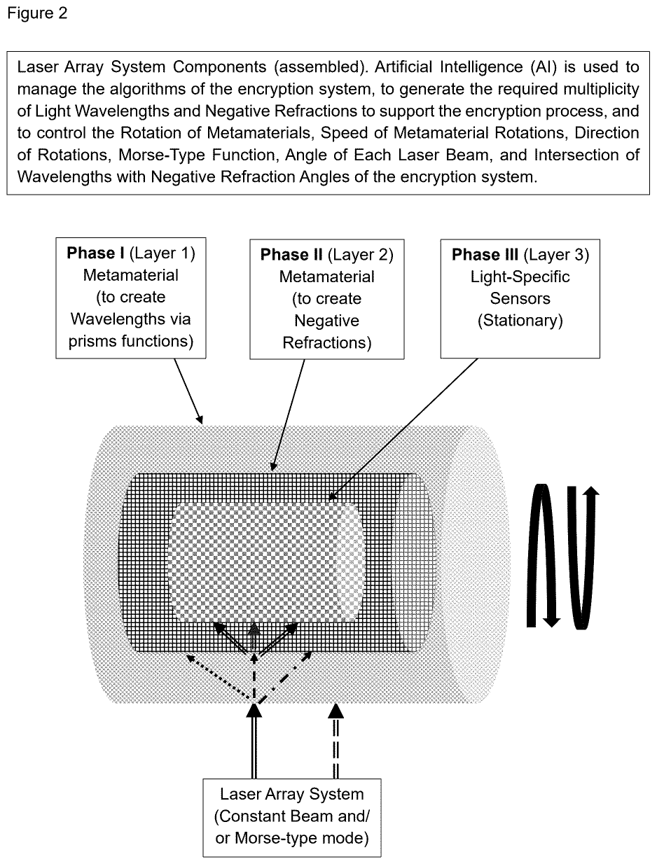

FIG. 3 depicts the Laser Array Systems targeting different locations of the metamaterial designed to function as a multi-prism system to generate multiple light spectrums to create multiple types of light wavelengths before Phase II.

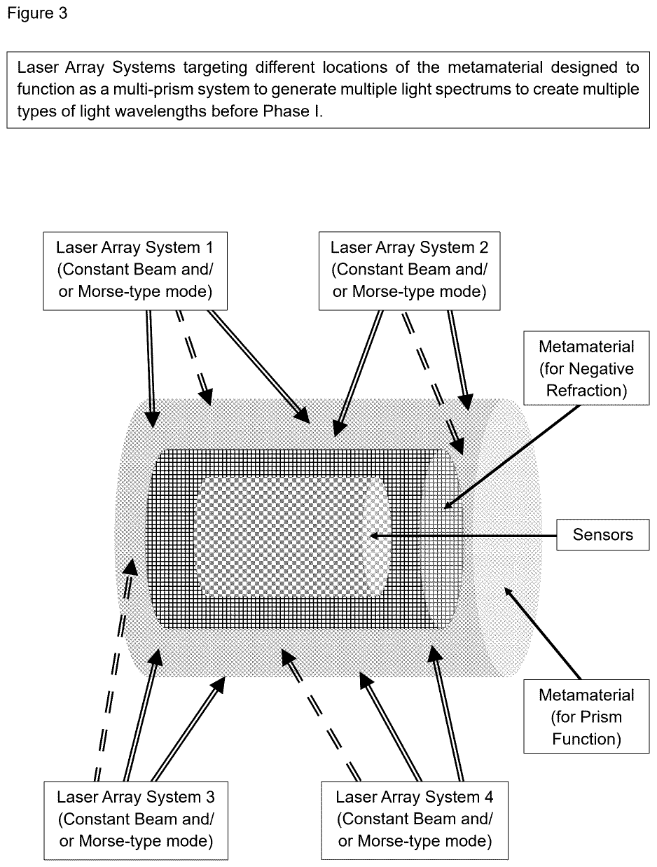

FIG. 4 depicts the stages of the Binary Encryption System.

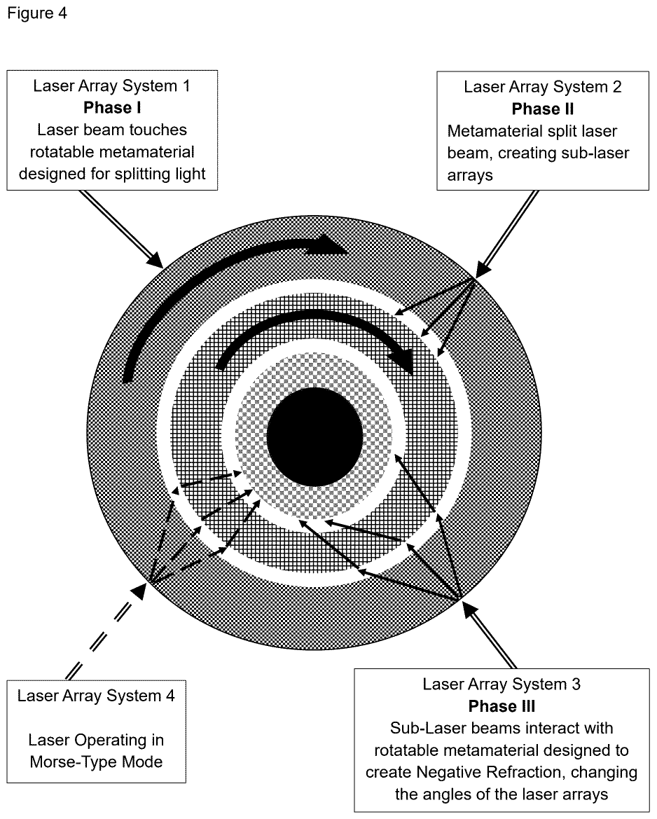

### DETAILED DESCRIPTION OF THE INVENTION

A binary encryption system based on multiple Negative Refraction interference patterns and a diverse assemblage of light wavelengths interception patterns driven by Artificial Intelligence (AI) wherein a Multi-Laser Array System comprised of multiple laser beams (light beams) operating simultaneously interacts with rotatable Anisotropic Optical Metamaterials to generate the said Negative Refraction interference patterns.

The said Multi-Laser Array System comprised of multiple laser beams operating simultaneously to also interact with rotatable metamaterials designed to function as a Multi-Prism Unit (metamaterials designed to function as a multi-prism system) to generate multiple light spectrums to create multiple types of light wavelengths to generate multiple sub-arrays with different wave amplitudes and different light wavelengths interception patterns to form the basis of the said binary encryption system controlled by AI.

The binary encryption system comprising of: a computer-driven AI system to operate the software and perform the algorithms required to support and process the instructions and mathematical calculations of the said binary encryption system; operating the said Multi-Laser Array System comprised of Multiple Angle-Independent laser beams interacting with Anisotropic Optical Metamaterials to generate the said Negative Refraction interference patterns, and where the Multiple Angle-Independent term refers to the ability of each laser comprising the Multi-Laser Array System array to independently move.

The binary encryption system operating the said Multi-Laser Array System wherein each laser beam generates different wave amplitudes and light wavelengths to create programmable-based interception patterns.

The binary encryption system is comprised of laser arrays to generate diverse light wavelengths, with each array generating simultaneously different wavelengths to generate multiple light waves interceptions at specific points.

The binary encryption system operating the said Multi-Laser Array System wherein the laser beams are either operating simultaneously in parallel or in a state of continuous alternation to perform a Morse-type function to be utilized as an additional basis to generate encryptions.

The binary encryption system receives light wavelengths by optical sensors and converted the said light wavelengths into digital data by AI.

The binary encryption system encodes the said digital data and stores securely the said digital data in computerized systems controlled by AI.

The binary encryption system encodes the functioning and transmission process of digital transmission systems to transmit digital data.

The binary encryption system based on a Multi-Laser Array System comprised of multiple laser beams interacting with rotatable Anisotropic Optical Metamaterials to generate the said Negative Refraction interference patterns and wherein the said Multi-Laser Array System comprised of multiple laser beams also interacts with rotatable metamaterials designed to function as a Multi-Prism Unit to generate multiple sub-arrays with different wave amplitudes and different light wavelengths interception patterns to form the basis of the said binary encryption system, wherein each array generates varying frequencies, polarizations, and spatial modes for the basis of the encryption system, and wherein the resulting angles created by the generation of Negative Refractions are utilized in conjunction with the said light wavelengths interception patterns to create a group of interception patterns based on the combination of angles and wavelengths controlled by AI.

The binary encryption system based on multiple Negative Refraction interference patterns and a diverse assemblage of light wavelengths interception patterns driven by Artificial Intelligence (AI) wherein a Multi-Laser Array System comprised of multiple laser beams interacts with rotatable Anisotropic Optical Metamaterials to generate the said Negative Refraction interference patterns and wherein the said Multi-Laser Array System comprised of multiple laser beams also interacts with rotatable metamaterials designed to function as a Multi-Prism Unit to generate multiple sub-arrays with different wave amplitudes and different light wavelengths interception patterns to form the basis of the said binary encryption system wherein the sub-array creation from the main laser array is split into smaller sub-arrays to be dedicated to encrypting different data streams or different parts of a message and wherein amplitude modulation utilizing digital techniques, the amplitude or intensity of each sub-array's laser beam is modulated to represent a series of data bits.

The binary encryption system creates sub-arrays laser beams from the main laser array through the use of metamaterials designed to function as prisms to split light and create sub-arrays and wherein each sub-array is potentially dedicated to encrypting different data streams or different parts of a message through different wave amplitudes and different light wavelengths interception patterns utilizing digital techniques and classical encryption keys to determine the specific amplitude values assigned to different data points.

Multiple laser arrays via VCSELs (Vertical-Cavity Surface-Emitting Lasers) or fiber-coupled emitters can transmit unique wavelengths in parallel. These lasers are spatially arranged so their beams intersect at programmable points in free-space or through optical waveguides.

The intercept structure of wavelengths is based on areas, specific points, and times when beams intersect are programmed and predetermined by secret patterns to create the unique pattern of interferences and wherein a slight phase shifts introduced into one of the sub-arrays would alter the final interference pattern in a specific, predictable way for the intended recipient.

The interference pattern generation is based on coherent laser beams overlap to produce a stable, high-contrast interference pattern. The specific shape and intensity distribution of the patterns depend on the relative phases of the overlapping laser beams.

I claim:

1) A binary encryption system based on multiple Negative Refraction interference patterns and a diverse assemblage of light wavelengths interception patterns driven by Artificial Intelligence (AI) wherein a Multi-Laser Array System comprised of multiple laser beams interacts with rotatable Anisotropic Optical Metamaterials to generate the said Negative Refraction interference patterns and wherein the said Multi-Laser Array System comprised of multiple laser beams also interacts with rotatable metamaterials designed to function as a Multi-Prism Unit to generate multiple sub-arrays with different wave amplitudes and different light wavelengths interception patterns to form the basis of the said binary encryption system, comprising of: a computer-driven Artificial Intelligence (AI) system to operate the software and perform the algorithms required to support and process the instructions and mathematical calculations of the said binary encryption system; operating the said Multi-Laser Array System comprised of Multiple Angle-Independent laser beams interacting with Anisotropic Optical Metamaterials to generate the said Negative Refraction interference patterns; operating the said Multi-Laser Array System wherein each laser beam generates different light wavelengths to create programmable-based interception patterns; operating the said Multi-Laser Array System wherein the laser beams are either operating simultaneously in parallel or in a state of continuous alternation to perform a Morse-type function to be utilized as an additional basis to generate encryptions by the said binary encryption system; receiving light wavelengths by optical sensors and be converted to digital data by AI; encoding the said digital data; storing securely the said digital data in computerized systems; encoding the functioning and transmission process of digital transmission systems for the purpose of protecting the transmission of digital data.

2) A binary encryption system based on multiple Negative Refraction interference patterns and a diverse assemblage of light wavelengths interception patterns driven by Artificial Intelligence (AI) wherein a Multi-Laser Array System comprised of multiple laser beams interacts with rotatable Anisotropic Optical Metamaterials to generate the said Negative Refraction interference patterns and wherein the said Multi-Laser Array System comprised of multiple laser beams also interacts with rotatable metamaterials designed to function as a Multi-Prism Unit to generate multiple sub-arrays with different wave amplitudes and different light wavelengths interception patterns to form the basis of the said binary encryption system, wherein each array generates varying frequencies, polarizations, and spatial modes for the basis of the encryption system, and wherein the resulting angles created by the generation of Negative Refractions are utilized in conjunction with the said light wavelengths interception patterns to create a group of interception patterns based on the combination of angles and wavelengths controlled by AI.

3) A binary encryption system based on multiple Negative Refraction interference patterns and a diverse assemblage of light wavelengths interception patterns driven by Artificial Intelligence (AI) wherein a Multi-Laser Array System comprised of multiple laser beams interacts with rotatable Anisotropic Optical Metamaterials to generate the said Negative Refraction interference patterns and wherein the said Multi-Laser Array System comprised of multiple laser beams also interacts with rotatable metamaterials designed to function as a Multi-Prism Unit to generate multiple sub-arrays with different wave amplitudes and different light wavelengths interception patterns to form the basis of the said binary encryption system wherein the sub-array creation from the main laser array is split into smaller sub-arrays to be dedicated to encrypting different data streams or different parts of a message and wherein amplitude modulation utilizing digital techniques, the amplitude or intensity of each sub-array's laser beam is modulated to represent a series of data bits.
